(19) United States
(12) Patent Application Publication
(10) Pub. No.: US 2026/0202140 A1
(43) Pub. Date: Jul. 16, 2026

(54) METHOD OF MANUFACTURING HEAT ACCUMULATOR, AND HEAT ACCUMULATOR

(71) Applicant: CENTRAL MOTOR WHEEL CO., LTD., Anjo-shi, Aichi (JP)

(72) Inventor: Noriyuki FUKAYA, Anjo-shi (JP)

(73) Assignee: CENTRAL MOTOR WHEEL CO., LTD., Anjo-shi, Aichi (JP)

(21) Appl. No.: 19/136,993

(22) PCT Filed: Dec. 13, 2022
(86) PCT No.: PCT/JP2022/045896

§ 371 Date: Jun. 9, 2025

(51) Int. Cl. F28D 20/00; F28D 21/00

(52) U.S. Cl. CPC F28D 20/0056; F28D 2021/004

(57) ABSTRACT

A method of manufacturing a heat accumulator is a method of manufacturing a heat accumulator to be used in a thermoacoustic device, and includes: a stacking step of obtaining a stack by stacking metal meshes; a compressing step of pressing the stack to keep the stack in a compressed state; and a fixing step of fixing an outer peripheral surface of the stack by disposing a fixing member on the outer peripheral surface of the stack in a state of being kept in the compressed state in the compressing step.

### TECHNICAL FIELD

The technology disclosed in this specification relates to a method of manufacturing a heat accumulator, and a heat accumulator.

### BACKGROUND ART

A thermoacoustic engine (a thermoacoustic device) includes a pipe in which a working gas that propagates acoustic waves is enclosed, and a prime mover (an energy converter) incorporated in the pipe. The energy converter includes a heat accumulator, and a heater and a cooler (heat exchangers) respectively disposed at both ends of the heat accumulator. Such an energy converter can be used as, for example, a thermoacoustic engine that converts thermal energy into acoustic energy (acoustic waves) by causing the working gas to perform self-excited vibration due to a temperature gradient generated between both the ends of the heat accumulator. (See Patent Literature 1). In general, as the temperature gradient between both the ends of the heat accumulator is larger, the conversion efficiency from the thermal energy into the acoustic energy is improved.

### CITATION LIST

### Patent Literature

Patent Literature 1: Japanese Unexamined Patent Application Publication No. 2017-3136 (JP 2017-3136 A)

### SUMMARY OF INVENTION

### Technical Problem

As the heat accumulator, a stack in which a large number of mesh thin plates are stacked is sometimes used. The stack is disposed inside of the pipe while being compressed. At this time, a phenomenon (springback) in which the compressed stack tries to return to its original shape occurs, resulting in that variations may be caused in the thickness of the stack and the distance between the adjacent metal meshes. There is a concern that the variations affect the temperature gradient between both the ends of the heat accumulator to make the performance of the heat accumulator unstable. It is to be noted that such a problem similarly arises even when the energy converter is used as an application other than the thermoacoustic engine described above (for example, a heat pump that performs heat transfer by inputting acoustic energy to the heat accumulator).

### Solution to Problem

(1) The technology disclosed by this specification is a method of manufacturing a heat accumulator to be used in a thermoacoustic device, the method including: a stacking step of obtaining a stack by stacking metal meshes; a compressing step of pressing the stack to keep the stack in a compressed state; and a fixing step of fixing an outer peripheral surface of the stack by disposing a fixing member on the outer peripheral surface of the stack in a state of being kept in the compressed state in the compressing step.

With the above-mentioned configuration, the springback of the stack can be prevented, and the performance of the heat accumulator can be stabilized.
(2) In the method of manufacturing the heat accumulator described in Item (1) above, the fixing member may be made of rubber.

With such a configuration, the fixing member fills a gap between the heat accumulator and a pipe accommodating the heat accumulator while being elastically deformed, and hence the heat accumulator can be stably held inside the pipe. Further, rubber has a thermal conductivity lower than that of metal, and hence, as compared with a case in which a fixing member made of rubber is not disposed around the stack, heat is less transmitted from the stack to the pipe, and hence reduction in working efficiency of the thermoacoustic device due to heat dissipation from the heat accumulator can be prevented.
(3) In the method of manufacturing the heat accumulator described in Item (2) above, the rubber may be liquid rubber.

With such a configuration, the fixing member can be easily formed on the outer peripheral surface of the stack. Further, the liquid rubber is impregnated from an outer peripheral edge of each metal mesh to a region slightly inward, and hence the outer peripheral edge of each metal mesh is firmly held by the fixing member.
(4) In the method of manufacturing the heat accumulator described in Item (3) above, the stacking step may include a step of bringing positioning portions of a positioning member into abutment against outer peripheral edges of the metal meshes, the positioning portions being spaced apart from one another.

With such a configuration, the liquid rubber can be applied in a state in which the outer peripheral edges of the metal meshes are aligned and positioned. This allows the outer peripheral edges of the metal meshes to be reliably held by the fixing member. Further, since the positioning portions are disposed to be spaced apart from one another, the outer peripheral edges of the metal meshes can be exposed through the gap between adjacent positioning portions, and the liquid rubber can be applied to this exposed part. This allows the liquid rubber to be easily applied in a state in which the outer peripheral edges of the metal meshes are positioned.
(5) The technology disclosed in this specification is a heat accumulator to be used in a thermoacoustic device, the heat accumulator including a stack in which metal meshes are stacked in a compressed state, and a fixing member fixed to an outer peripheral surface of the stack.

With the above-mentioned configuration, the springback of the stack can be prevented, and the performance of the heat accumulator can be stabilized.

### Advantageous Effects of Invention

With the method of manufacturing the heat accumulator, and the heat accumulator disclosed in this specification, the springback of the stack can be prevented, and the performance of the heat accumulator can be stabilized.

### BRIEF DESCRIPTION OF DRAWINGS

FIG. 1 is a perspective view illustrating a thermoacoustic device of an embodiment while being partially cutaway.

FIG. 2 is a sectional view taken along the line II-II of FIG. 1.

FIG. 3 is a perspective view of a heat accumulator of the embodiment.

FIG. 4 is a perspective view of a positioning member of the embodiment.

FIG. 5 is a side view illustrating a state before a first pressing member and metal meshes are set to the positioning member in a method of manufacturing a heat accumulator of the embodiment.

FIG. 6 is a side view illustrating a state in which the first pressing member and the metal meshes are set to the positioning member in the method of manufacturing the heat accumulator of the embodiment.

FIG. 7 is a side view illustrating a state in which the metal meshes set to the positioning member are compressed by the first pressing member and a second pressing member in the method of manufacturing the heat accumulator of the embodiment.

### DESCRIPTION OF EMBODIMENTS

Specific examples of the technology disclosed in this specification are described below with reference to the drawings. It is to be noted that the present invention is not limited to those examples. The present invention is indicated by the claims, and is intended to include all modifications within the meaning and scope equivalent to the claims.

### Embodiment

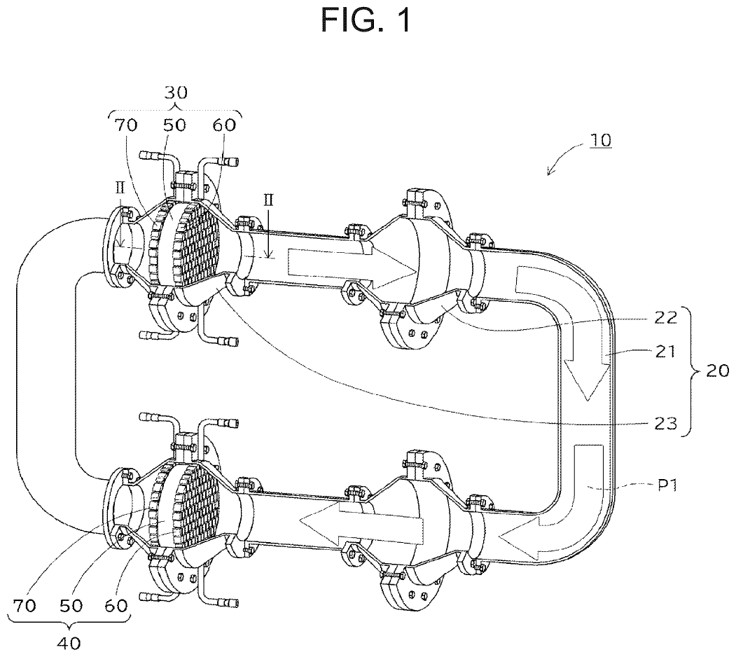

An embodiment is described with reference to FIG. 1 to FIG. 7. A thermoacoustic device 10 of this embodiment is a cooling device that maintains the temperature of an object at a temperature lower than room temperature by utilizing acoustic energy.

### Overall Configuration of Thermoacoustic Device 10

The thermoacoustic device 10 includes, as illustrated in FIG. 1, a pipe 20, and a prime mover 30 and a cooler 40 disposed in the middle of the pipe 20.

The pipe 20 includes, as illustrated in FIG. 1, a plurality of main pipes 21, a plurality (two in this embodiment) of expanding pipes 22, and a plurality (two in this embodiment) of accommodating pipes 23. In this embodiment, the main pipes 21, the expanding pipes 22, and the accommodating pipes 23 are made of metal. The main pipes 21 are each a pipe having a constant inner diameter. The expanding pipes 22 are each a pipe having an inner diameter in a center part between both ends that is larger than that of the main pipe 21.

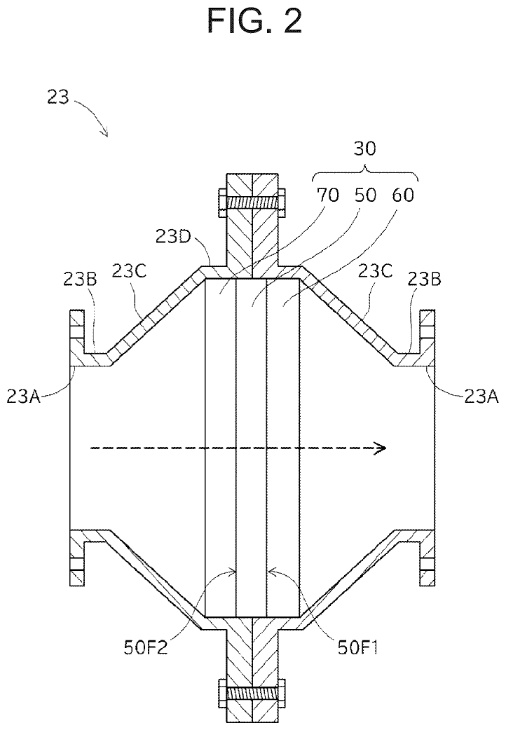

The accommodating pipes 23 are each, as illustrated in FIG. 1 and FIG. 2, a pipe having an inner diameter in a center part between both ends that is larger than that of the main pipe 21. More specifically, the accommodating pipes 23 are each a pipe having opening portions 23A at both ends, and includes two first straight pipe portions 23B, two tapered portions 23C, and a second straight pipe portion 23D. The two first straight pipe portions 23B are two short straight pipe-shaped parts respectively adjacent to the two opening portions 23A. The second straight pipe portion 23D is a short straight pipe-shaped part that is located at the middle between the two first straight pipe portions 23B and has an inner diameter larger than that of the first straight pipe portion 23B. The two tapered portions 23C are parts that respectively provide connection between one first straight pipe portion 23B and the second straight pipe portion 23D and between the other first straight pipe portion 23B and the second straight pipe portion 23D, and are narrowed in diameter from the second straight pipe portion 23D toward the first straight pipe portions 23B.

The plurality of main pipes 21 provides connection between the two accommodating pipes 23, between the accommodating pipe 23 and the expanding pipe 22, and between the two expanding pipes 22. The main pipes 21, the expanding pipes 22, and the accommodating pipes 23 configure a loop-shaped pipe conduit P1. A working gas is enclosed inside the pipe conduit P1. The working gas is not particularly limited as long as the working gas is a gas that can transmit acoustic waves, but it is preferable to use an inert gas such as helium, argon, or a mixture gas of helium and argon, or air.

### Configuration of Prime Mover 30

The prime mover 30 is a device that converts thermal energy into acoustic energy (acoustic waves), and is disposed inside of one accommodating pipe 23 (the accommodating pipe 23 on the upper side of FIG. 1). The prime mover 30 includes, as illustrated in FIG. 1 and FIG. 2, a heat accumulator 50, a first heat exchanger 60, and a second heat exchanger 70. The first heat exchanger 60, the heat accumulator 50, and the second heat exchanger 70 are disposed side by side in the stated order from one opening portion 23A toward the other opening portion 23A.

### Heat Accumulator 50

The heat accumulator 50 has a thick disk shape having one surface 50F1 (the surface on the right side of FIG. 2) and another surface 50F2 (the surface on the left side of FIG. 2). The heat accumulator 50 is disposed in a posture perpendicular to an axial direction of the accommodating pipe 23 (the right-left direction of FIG. 2) with the one surface 50F1 facing the one opening portion 23A and the other surface 50F2 facing the other opening portion 23A.

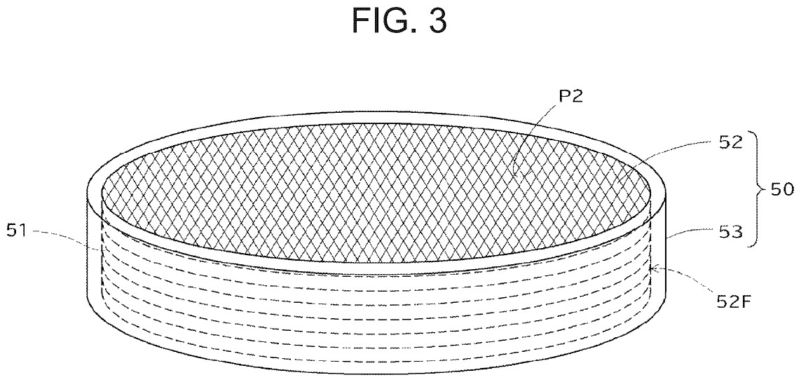

The heat accumulator 50 includes, as illustrated in FIG. 3, a stack 52 in which a plurality of circular metal meshes 51 is stacked in a compressed state, and a fixing member 53 fixed to an outer peripheral surface 52F of the stack 52. The metal meshes 51 are each a mesh-like member in which a plurality of thin metal wires is woven. The plurality of metal meshes 51 has outer shapes that are substantially equal to each other, and is stacked with outer peripheral edges being aligned in position. The outer peripheral surface 52F of the stack 52 is a surface formed by continuously providing the outer peripheral edges of the plurality of stacked metal meshes 51. The stack 52 is formed by continuously providing the meshes (gaps between the thin wire and the thin wire) of the plurality of metal meshes 51, and has a large number of fine through paths P2 that pass through the stack 52 from the one surface 50F1 to the other surface 50F2.

The fixing member 53 is fixed to the outer peripheral surface 52F of the stack 52, and has a role of holding the outer peripheral edges of the plurality of metal meshes 51 so that the outer peripheral edges are prevented from separating from each other. The fixing member 53 keeps the plurality of metal meshes 51 in a state that is more compressed than a state in which the meshes are simply stacked without the outer peripheral edges being fixed. The fixing member 53 covers the entire outer peripheral surface 52F of the stack 52. That is, the fixing member 53 is disposed around the entire circumference of the outer peripheral surface 52F of the stack 52, and is disposed along the entire length in the thickness direction of the stack 52 (from a position adjacent to the one surface 50F1 to a position adjacent to the other surface 50F2).

In this embodiment, the fixing member 53 is made of silicone rubber. In a state in which the heat accumulator 50 is disposed inside of the accommodating pipe 23, the fixing members 53 fills a gap between the stack 52 and an inner peripheral surface of the accommodating pipe 23 while being elastically deformed. This makes it possible to avoid unexpected falling of the heat accumulator 50 from the accommodating pipe 23. Further, the silicone rubber configuring the fixing member 53 has a thermal conductivity lower than that of the metal configuring the metal mesh 51. Therefore, when the fixing member 53 is interposed between the stack 52 and the accommodating pipe 23, it is possible to reduce heat dissipation from the stack 52 to the accommodating pipe 23 as compared with a case in which the fixing member 53 is not interposed. The thickness of the fixing member 53 is not particularly limited as long as the fixing member 53 can fix the outer peripheral edges of the plurality of metal meshes 51, but, from the viewpoint of reliably fixing the outer peripheral edges of the plurality of metal meshes 51 with the minimum necessary thickness and reducing the heat dissipation from the stack 52 to the accommodating pipe 23, the thickness of the fixing member 53 is preferably approximately 0.5 mm or more and 1 mm or less.

### First Heat Exchanger 60, Second Heat Exchanger 70

The first heat exchanger 60 is, as illustrated in FIG. 2, disposed adjacent to the one surface 50F1 of the heat accumulator 50. As the first heat exchanger 60, for example, a publicly-known heat exchanger including a heat transfer tube through which a medium passes and fins disposed around the heat transfer tube can be used. A high-temperature heating medium is supplied to the inside of the heat transfer tube, and heat exchange is performed between the working gas in the vicinity of the first heat exchanger 60 and the heating medium. As the heating medium, for example, heating medium oil warmed by exhaust heat from a factory can be used.

The second heat exchanger 70 is, as illustrated in FIG. 2, disposed adjacent to the other surface 50F2 of the heat accumulator 50. As the second heat exchanger 70, for example, a publicly-known heat exchanger including a heat transfer tube through which a medium passes and fins disposed around the heat transfer tube can be used. A medium having a temperature lower than that of the heating medium (water at room temperature in this embodiment) is supplied to the inside of the heat transfer tube, and thus the working gas in the vicinity of the second heat exchanger 70 becomes a temperature lower than the temperature of the heating medium.

### Configuration of Cooler 40

The cooler 40 is a heat pump that generates a temperature gradient by receiving acoustic energy generated by the prime mover 30 as input and maintains the temperature of the object at a temperature lower than room temperature, and is disposed inside the other accommodating pipe 23 as illustrated in FIG. 1. The cooler 40 includes a heat accumulator 50, and a first heat exchanger 60 and a second heat exchanger 70 respectively disposed on both sides of the heat accumulator 50. The heat accumulator 50 and the heat exchangers 60, 70 included in the cooler 40 have configurations similar to the heat accumulator 50 and the heat exchangers 60, 70 included in the prime mover 30. A medium having a constant temperature (water at room temperature in this embodiment) is supplied to the inside of the heat transfer tube in the first heat exchanger 60, and the working gas in the vicinity of the first heat exchanger 60 becomes a temperature equivalent to room temperature. The heat transfer tube in the second heat exchanger 70 is connected to a heat exchanger included in an external cooling facility, and a refrigerant circulates inside this heat transfer tube.

### Method of Manufacturing Heat Accumulator 50

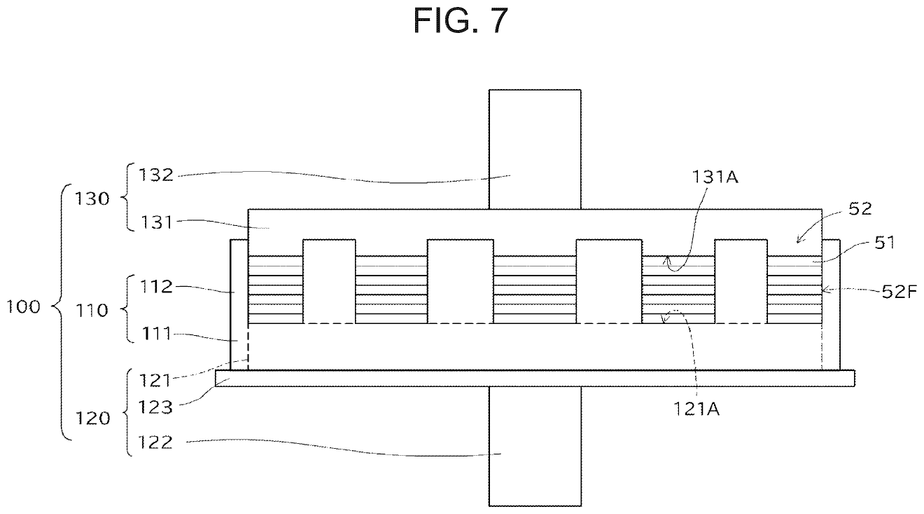

A manufacturing apparatus 100 that manufactures the heat accumulator 50 includes, as illustrated in FIG. 7, a positioning member 110, a first pressing member 120, and a second pressing member 130.

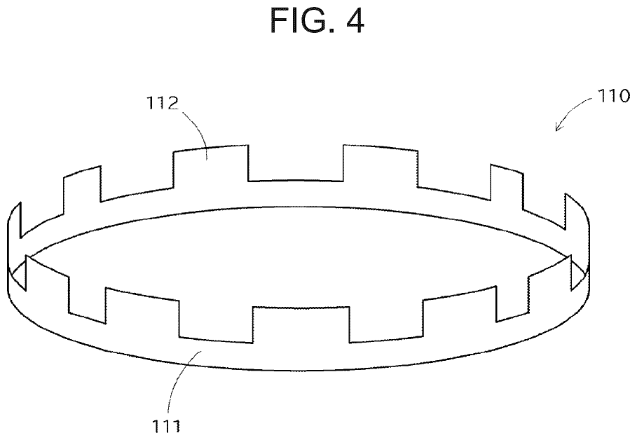

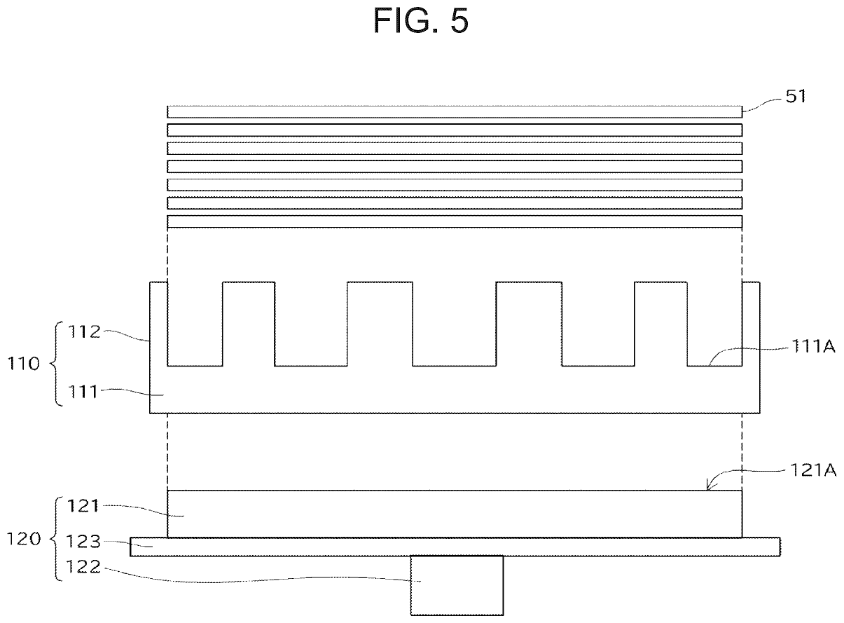

The positioning member 110 includes, as illustrated in FIG. 4 and FIG. 5, a short cylindrical frame 111 having both opened ends, and a plurality of positioning portions 112 extending from one opening edge 111A of the frame 111 and being disposed to be spaced apart from one another. The inner diameter of the frame 111 is substantially equal to the outer diameter of the metal mesh 51. Each positioning portion 112 has a plate shape. The plurality of positioning portions 112 is disposed at equal intervals along the opening edge 111A of the frame 111.

The first pressing member 120 includes, as illustrated in FIG. 5 to FIG. 7, a first pressing plate 121, a stop plate 123 disposed to overlap the first pressing plate 121, and a first support portion 122 extending from the stop plate 123. The first pressing plate 121 has a disk shape having an outer diameter substantially equal to the outer diameter of the metal mesh 51, and one of both front and back surfaces serves as a first pressing surface 121A to be in contact with the stack 52. The stop plate 123 has a disk shape that is one size larger than the first pressing plate 121, and is disposed concentrically with the first pressing plate 121. The first support portion 122 extends from a surface of the stop plate 123 on a side opposite to the first pressing plate 121, and supports the first pressing plate 121 and the stop plate 123.

The second pressing member 130 includes, as illustrated in FIG. 7, a second pressing plate 131, and a second support portion 132 extending from the second pressing plate 131. The second pressing plate 131 has a disk shape having an outer diameter substantially equal to the outer diameter of the metal mesh 51, and one of both front and back surfaces serves as a second pressing surface 131A to be in contact with the stack 52. The second support portion 132 extends from a surface of the second pressing plate 131 on a side opposite to the second pressing surface 131A, and supports the second pressing plate 131.

Next, a procedure of manufacturing the heat accumulator 50 with the use of the above-mentioned manufacturing apparatus 100 is described.

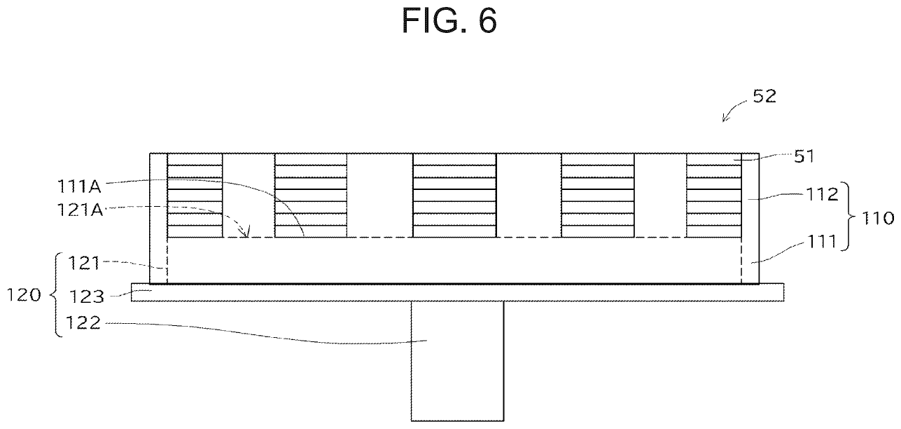

As illustrated in FIG. 6, first, the frame 111 is attached to the first pressing plate 121 in a posture in which the plurality of positioning portions 112 faces a direction opposite to the stop plate 123. The frame 111 is disposed to surround the first pressing plate 121. One end of the frame 111 (the lower end in FIG. 6) abuts against the stop plate 123, and thus the positioning member 110 is positioned relative to the first pressing plate 121 so that the position of the opening edge 111A is aligned with the position of the first pressing surface 121A. Next, the plurality of metal meshes 51 is sequentially stacked and disposed on the first pressing surface 121A (a stacking process). At this stage, the stack 52 of the plurality of metal meshes 51 is simply stacked and no external force is applied thereto, and the stack 52 is in an uncompressed state. The plurality of positioning portions 112 is disposed to surround the plurality of metal meshes 51, and the outer peripheral edges of the metal meshes 51 abut against the positioning portions 112. In this manner, the outer peripheral edges of the plurality of metal meshes 51 are positioned to be aligned with each other.

Next, as illustrated in FIG. 7, the second pressing plate 131 is placed on the stack 52, and the stack 52 is sandwiched between the first pressing plate 121 and the second pressing plate 131. At this time, the second pressing surface 131A is brought into contact with the stack 52. Next, the second pressing plate 131 is pressed in a direction approaching the first pressing plate 121 (downward in FIG. 7), and the stack 52 is compressed between the first pressing plate 121 and the second pressing plate 131 (a compressing step). The stack 52 becomes a designed compressed state by pushing in the second pressing plate 131 until the distance between the first pressing surface 121A and the second pressing surface 131A becomes a predetermined distance.

Next, while the stack 52 is kept in a compressed state, liquid rubber is applied to the outer peripheral surface 52F of the stack 52 and dried to form the fixing member 53 (a fixing step). Liquid rubber is a polymer that has fluidity in the state of room temperature and under atmospheric pressure before being applied to an object, but hardens by being subjected to treatment such as drying or heating after the application, and can form a rubber elastic body. The liquid rubber may contain a crosslinking agent, a crosslinking accelerator, and other blending agents. The type of the liquid rubber to be used is not particularly limited, and may be diene rubber based, silicone rubber based, urethane rubber based, or polysulfide rubber based. In this embodiment, a silicone rubber-based liquid rubber that forms a rubber elastic body by being dried after the application (for example, ULTRA Cooper Gasket Maker Exhaust 81878 produced by Permatex) is exemplified as a suitable liquid rubber.

First, the liquid rubber is applied to parts of the outer peripheral surface 52F of the stack 52 that are exposed from the positioning portions 112. The outer peripheral edges of the plurality of metal meshes 51 are aligned in advance by the positioning portions 112 in the stacking step, and hence the liquid rubber can be applied smoothly and reliably to the outer peripheral surface 52F. The metal meshes 51 configuring the stack 52 are mesh-like members, and hence the applied liquid rubber is impregnated from the outer peripheral edge of each metal mesh 51 to a position slightly inward.

After the application, the stack 52 is left at room temperature for a while so that the liquid rubber is dried. After the liquid rubber is dried, the positioning member 110 is rotated relative to the stack 52 while maintaining the state in which the stop plate 123 is in abutment against the frame 111, and parts of the outer peripheral surface 52F to which the liquid rubber is not applied are exposed from the positioning portions 112. Liquid rubber is applied to the exposed parts and dried. With those steps being repeated, the fixing member 53 is formed on the entire outer peripheral surface 52F. In this manner, the heat accumulator 50 is completed. As described above, the liquid rubber is impregnated from the outer peripheral edge of each metal mesh 51 to a position slightly inward, and hence the fixing member 52 is formed in a shape that bites into a position slightly inward of the outer peripheral edge of each metal mesh 51. As a result, the outer peripheral edge of each metal mesh 51 is firmly held by the fixing member 52, and springback of the stack 52 can be more reliably avoided.

### Operation of Thermoacoustic Device 10

When the thermoacoustic device 10 is to be activated, a heating medium is caused to flow through the first heat exchanger 60 included in the prime mover 30. Then, in the heat accumulator 50 included in the prime mover 30, heat exchange is performed between the working gas in the vicinity of the one surface 50F1 and the heating medium. As a result, the temperature of the working gas in the vicinity of the one surface 50F1 in the heat accumulator 50 is adjusted to approach the temperature of the heating medium. Further, water at room temperature is caused to flow through the second heat exchanger 70 included in the prime mover 30. Then, in the heat accumulator 50, heat exchange is performed between the working gas in the vicinity of the other surface 50F2 and the water at room temperature. As a result, the temperature of the working gas in the vicinity of the other surface 50F2 in the heat accumulator 50 is adjusted to approach room temperature.

Such actions of the heat exchangers 60, 70 cause a temperature gradient between the one surface 50F1 and the other surface 50F2 of the heat accumulator 50. Then, the working gas inside the through paths P2 becomes unstable and starts to vibrate. This vibration generates acoustic energy (acoustic waves). The generated acoustic energy is output from the one surface 50F1 of the heat accumulator 50 (the surface on which the first heat exchanger 60 is disposed), and is transmitted via the working gas enclosed inside the pipe conduit P1 to reach the cooler 40 (see the arrows in FIG. 1).

When the acoustic energy transmitted by the working gas is input to the heat accumulator 50 included in the cooler 40, a temperature gradient is caused between the one surface 50F1 and the other surface 50F2. Since water at room temperature flows through the first heat exchanger 60 disposed on the input side of the acoustic energy in the cooler 40, the temperature of the working gas in the vicinity of the second heat exchanger 70 in the heat accumulator 50 is adjusted to a temperature lower than room temperature by the amount of the generated temperature gradient. Heat exchange is performed between this working gas having a temperature lower than room temperature and the refrigerant, and the refrigerant that has become a low temperature is supplied to the external cooling facility so that the object is cooled.

It has been presumed from previous researches that, in order to stably generate acoustic energy from the temperature gradient between the one surface 50F1 and the other surface 50F2 of the heat accumulator 50 and stably generate the temperature gradient between the one surface 50F1 and the other surface 50F2 of the heat accumulator 50 by the input of the acoustic energy, the through paths P2 included in the heat accumulator 50 are required to be as fine as possible. Accordingly, it is considered to be preferable to keep the stack 52 configuring the heat accumulator 50 in a compressed state. However, when the stack 52 is simply compressed and disposed inside the accommodating pipe 23, a phenomenon (springback) in which the compressed stack 52 tries to return to its original shape occurs, resulting in that variations may be caused in the thickness of the entire stack 52 and the distance between adjacent metal meshes 51. There is a concern that the variations affect the temperature gradient between both the ends of the heat accumulator 50 to make the performance of the heat accumulator 50 unstable. In this embodiment, the fixing member 53 is disposed and fixed to the outer peripheral surface 52F in a state in which the stack 52 in which the plurality of metal meshes 51 is stacked is kept in a compressed state. With such a configuration, the springback of the stack 52 can be prevented, and the performance of the heat accumulator 50 can be stabilized.

### Actions and Effects

As described above, the method of manufacturing the heat accumulator 50 of this embodiment is a method of manufacturing the heat accumulator 50 to be used in the thermoacoustic device 10, and includes: a stacking step of obtaining the stack 52 by stacking the plurality of metal meshes 51; a compressing step of pressing the stack 52 to keep the stack 52 in a compressed state; and a fixing step of fixing the outer peripheral surface 52F of the stack 52 by disposing the fixing member 53 on the outer peripheral surface 52F of the stack 52 in a state of being kept in the compressed state in the compressing step.

Further, the heat accumulator 50 in this embodiment is the heat accumulator 50 to be used in the thermoacoustic device 10, and includes the stack 52 in which the plurality of metal meshes 51 is stacked in a compressed state, and the fixing member 53 fixed to the outer peripheral surface 52F of the stack 52.

With the above-mentioned configuration, the springback of the stack 52 can be suppressed, and the performance of the heat accumulator 50 can be stabilized.

In the above-mentioned method of manufacturing the heat accumulator 50, the fixing member 53 is made of rubber.

With such a configuration, the fixing member 53 fills the gap between the heat accumulator 50 and the accommodating pipe 23 accommodating the heat accumulator 50 while being elastically deformed, and hence the heat accumulator 50 can be stably held inside the accommodating pipe 23. Further, rubber has a thermal conductivity lower than that of metal, and hence, as compared with a case in which the fixing member 53 made of rubber is not disposed around the stack 52, heat is less transmitted from the stack 52 to the accommodating pipe 23, and hence reduction in working efficiency due to heat dissipation from the heat accumulator 50 can be prevented.

In the above-mentioned method of manufacturing the heat accumulator 50, liquid rubber is used. With such a configuration, the fixing member 53 can be easily formed on the outer peripheral surface 52F of the stack 52. Further, the liquid rubber is impregnated from the outer peripheral edge of each metal mesh 51 to a region slightly inward, and hence the outer peripheral edge of each metal mesh 51 is firmly held by the fixing member 53.

In the above-mentioned method of manufacturing the heat accumulator 50, the stacking step includes a step of bringing the positioning portions 112 of the positioning member 110 including the plurality of positioning portions 112 disposed to be spaced apart from one another into abutment against outer peripheral edges of the plurality of metal meshes 51.

With such a configuration, the liquid rubber can be applied in a state in which the outer peripheral edges of the plurality of metal meshes 51 are aligned and positioned. This allows the outer peripheral edges of the plurality of metal meshes 51 to be reliably held by the fixing member 53. Further, since the positioning portions 112 are disposed to be spaced apart from one another, the outer peripheral edges of the metal meshes 51 can be exposed through the gap between adjacent positioning portions 112, and the liquid rubber can be applied to this exposed part. This allows the liquid rubber to be easily applied in a state in which the outer peripheral edges of the metal meshes 51 are positioned.

### Other Embodiments

(1) In the above-mentioned embodiment, the thermoacoustic device 10 is a cooling device, but the thermoacoustic device is not required to be a cooling device. For example, the thermoacoustic device may be a heating device including a heat pump for heating in place of the cooler 40, or may be a power generation device including a generator that converts acoustic waves output from a prime mover into electric power.
(2) In the above-mentioned embodiment, the pipe 20 has a loop shape, but, for example, the pipe 20 may include a branching pipe that branches from the loop-shaped pipe.
(3) In the above-mentioned embodiment, the thermoacoustic device 10 includes one prime mover 30, but the thermoacoustic device may include a plurality of prime movers.
(4) In the above-mentioned embodiment, the thermoacoustic device 10 includes two expanding pipes 22, but the number of expanding pipes may be one or three or more, or the thermoacoustic device is not required to include an expanding pipe.
(5) In the above-mentioned embodiment, the heat accumulator 50 has a disk shape, but the shape of the heat accumulator is not particularly limited, and the heat accumulator may have, for example, a polygonal plate shape.
(6) In the above-mentioned embodiment, the accommodating pipe 23 is a pipe having an inner diameter in the center part between both the ends that is larger than that of the main pipe 21, but the shape of the part of the pipe that accommodates the heat accumulator is not particularly limited, and the shape may be any shape that can accommodate the heat accumulator.
(7) In the above-mentioned embodiment, silicone rubber is exemplified as the material of the fixing member 53, but the material of the fixing member 53 is not particularly limited as long as the outer peripheral edges of the plurality of metal meshes can be held. The fixing member may be made of, for example, rubber other than silicone rubber, or a material other than rubber (for example, resin or metal). From the viewpoint of preventing the transfer of heat to the pipe, it is preferable that the fixing member be made of a material having a thermal conductivity lower than that of the metal configuring the metal mesh.
(8) In the above-mentioned embodiment, liquid rubber is used to form the fixing member, but, for example, the fixing member may be configured of a sheet made of rubber, resin, or the like, and an adhesive that fixes the sheet to the periphery of the stack.
(9) In the above-mentioned embodiment, the fixing member 53 is formed around the entire circumference on the outer peripheral surface of the stack 52, but the fixing member 53 is not required to be formed around the entire circumference on the outer peripheral surface of the stack as long as the plurality of metal meshes can be held in a compressed state. For example, a plurality of fixing members may be disposed to be spaced apart on the outer peripheral surface of the stack.
(10) In the above-mentioned embodiment, the positioning member 110 is used to align the outer peripheral edges of the plurality of metal meshes 51, but the positioning member is not always required to be used. For example, an operator may manually align the outer peripheral edges of the plurality of metal meshes 51.
(11) In the above-mentioned embodiment, the positioning member 110 is positioned relative to the first pressing plate 121 by the stop plate 123 included in the first pressing member 120, but a configuration for positioning the positioning member relative to the first pressing plate may be any configuration. For example, a locking protrusion portion protruding from the positioning member to be locked to the first pressing member may be used.

### REFERENCE SIGNS LIST

10: thermoacoustic device
50: heat accumulator
51: metal mesh
52: stack
52F: outer peripheral surface
53: fixing member
120: positioning member
112: positioning portion

1. A method of manufacturing a heat accumulator to be used in a thermoacoustic device, the method comprising:
a stacking step of obtaining a stack by stacking metal meshes;
a compressing step of pressing the stack to keep the stack in a compressed state; and
a fixing step of fixing an outer peripheral surface of the stack by disposing a fixing member on the outer peripheral surface of the stack in a state of being kept in the compressed state in the compressing step.

2. The method of manufacturing the heat accumulator according to claim 1, wherein the fixing member is made of rubber.

3. The method of manufacturing the heat accumulator according to claim 2, wherein the rubber is liquid rubber.

4. The method of manufacturing the heat accumulator according to claim 3, wherein the stacking step includes a step of bringing positioning portions of a positioning member into abutment against outer peripheral edges of the metal meshes, the positioning portions being spaced apart from one another.

5. A heat accumulator to be used in a thermoacoustic device, the heat accumulator comprising:
a stack in which metal meshes are stacked in a compressed state; and
a fixing member fixed to an outer peripheral surface of the stack.
